(19) United States
(12) Patent Application Publication
(10) Pub. No.: US 2011/0001681 A1
(43) Pub. Date: Jan. 6, 2011

(54) MULTIBAND ANTENNA

(75) Inventor: Mao-Hsiu HSU, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/613,660

(22) Filed: Nov. 6, 2009

(30) Foreign Application Priority Data
Jul. 2, 2009 (CN) 200920305547.7

(51) Int. Cl. H01Q 9/04; H01Q 1/50

(52) U.S. Cl. 343/860; 343/700 MS

(57) ABSTRACT

A multiband antenna includes a feed portion, a radiating portion and a matching portion. The radiating portion is operable to transceive electromagnetic signals, and includes a first radiator, a second radiator and a third radiator. The first radiator is connected to the feed portion, and includes a first free end and a second free end. The second radiator is bent, and includes a first feed end and a third free end, wherein the first feed end is connected to the feed portion. The third radiator is substantially L shaped, and includes a second feed end and a fourth free end, wherein the second feed end is electrically connected to the feed portion. The matching portion is rectangularly shaped, and electrically connected to the first radiator, for impedance matching.

### BACKGROUND

1. Technical Field

Embodiments of the present disclosure relate to antennas, and especially to a multiband antenna.

2. Description of Related Art

Planar inverter-F antennas (PIFA) are widely applied in research and application, due to their capacity for minimal volume in various shapes.

However, PIFA operational frequency bands narrow when physical dimensions of the PIFA are decreased, to a point where working bands of the host device may not be covered. In one example, the problem may be reduced by increasing the distance between the PIFA and ground, but this method increases device volume of the host device. Another method is to change the shape of the PIFA, but this method requires a redesign of the PIFA antenna, which may be costly. In yet another method, a monopole antenna rather than PIFA may be used, but the monopole antenna generally exhibits a higher specific absorption rate (SAR), and is harder for impedance matching.

### BRIEF DESCRIPTION OF THE DRAWINGS

FIG. 1 is a schematic diagram of an embodiment of a multiband antenna according to the present disclosure;

FIG. 2 illustrates exemplary dimensions of the multiband antenna of FIG. 1; and

FIG. 3 is a graph showing exemplary return loss of the multiband antenna of FIG. 1.

### DETAILED DESCRIPTION

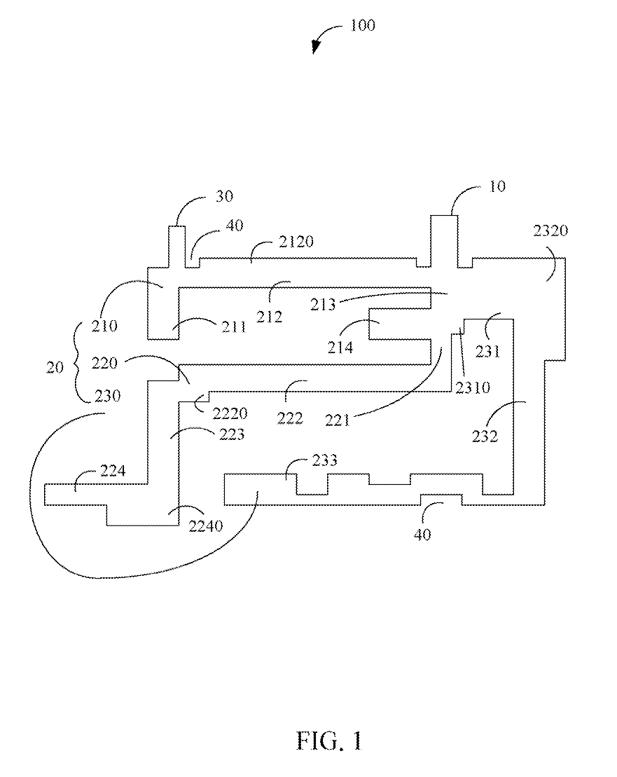

Referring to FIG. 1, a schematic diagram of an embodiment of a multiband antenna 100 as disclosed is shown. The multiband antenna 100 may be made of flexible metal, and is easily assembled. In one embodiment, the multiband antenna 100 comprises a feed portion 10, a radiating portion 20 and a matching portion 30.

The feed portion 10 supplies electromagnetic signals, and is rectangularly shaped.

The radiating portion 20 is electrically connected to the feed portion 10, to transceive electromagnetic signals. In one embodiment, a profile of the radiating portion 20 is substantially rectangularly shaped, and defines a plurality of slots 40. The radiating portion 20 comprises a first radiator 210, a second radiator 220 and a third radiator 230.

The first radiator 210 is substantially inverted-C shaped, and connected to the feed portion 10. The first radiator 210 comprises a first free end 211, a first horizontal section 212, a perpendicular section 213 and a second free end 214. In one embodiment, the first free end 211 is perpendicular to the second free end 214, the first free end 211 is parallel to the first perpendicular section 213, and the second free end 214 is parallel to the first horizontal section 212. The second free end 214 is shorter than the first horizontal section 212. The first horizontal section 212 comprises a first protrusion 2120 in the center. The feed portion 10 and the matching portion 30 are configured on the two ends of the first horizontal section 212 to define slots 40 with the first protrusion 2120.

The matching portion 30 is rectangularly shaped, and electrically connected to the first radiator 210, for impedance matching. In one embodiment, the matching portion 30 and the feed portion 10 are configured on the same side of the radiating portion 20.

The second radiator 220 is bent, and comprises a first feed end 221, a second horizontal section 222, a second perpendicular section 223 and a third free end 224. In one embodiment, the first feed end 221 is connected to feed portion 10 by the first perpendicular section 213. The second horizontal section 222 comprises a second protrusion 2220, and the third free end 224 comprises a third protrusion 2240, to adjust frequency bands of the second radiator 220.

The third radiator 230 is substantially L shaped, and comprises a second feed end 231, a third perpendicular section 232 and a fourth free end 233. In one embodiment, the second feed end 231 is electrically connected to the feed portion 10. The second feed portion 231 comprises a fourth protrusion 2310, the juncture of the feed portion 231 and the third perpendicular section 232 comprises a fifth protrusion 2320, to adjust frequency bands of the third radiator 230. The fourth free end 233 is wave-shaped. The fourth free end 223 and the third free end 224 are in the same line and parallel to the second free end 214, to radiate directionally. In one embodiment, the second radiator 220 and the third radiator 230 are operable in low frequency bands, such as, approximately 1.0 GHz.

In another embodiment, the radiating portion 20 comprises a plurality of radiators 210, 220 230, each radiator constituting one or more L shaped radiating sections connected in series. For example, the first radiator 210 may comprise a L shape consisting of the first free end 211 and the first horizontal section 212, and a L shape consisting of the first perpendicular section 213 and the second free end 214. One end of each radiator 210, 220 and 230 is connected to the feed portion 10, for example radiating section 231 of the radiator 230 electrically connecting to the feed portion 10. Protrusions are configured on one or more radiating sections on the radiators 210, 220 and 230, such as, for example, on the radiating section 212.

The first protrusion 2120, the second protrusion 2220, the third protrusion 2240, the fourth protrusion 2310, and the fifth protrusion 2320 may be rectangular, triangular, or L shaped.

The slots 40 are defined by the bend of the radiating portion 20, and junctures of the feed portion 10 and the radiating portion 20 and junctures of the matching portion 30 and the radiating portion 10, to add couple effectiveness.

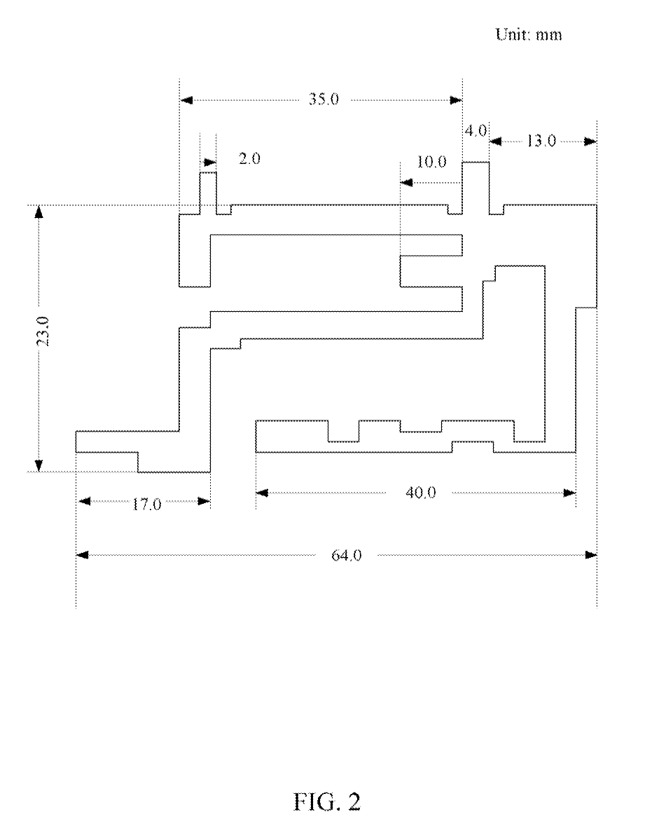

FIG. 2 illustrates exemplary dimensions of the multiband antenna of FIG. 1. However, it should be understood that the disclosure is not limited thereto, and may include other dimensions according to the embodiment. As shown in FIG. 2, a width of the feed portion 10 may be approximately 4.0 cm, and a width of the matching portion 30 may be approximately 2.0 cm. A length of outline of the radiating portion 20 may be approximately 64.0 cm, and a width may be approximately 23.0 cm. A length of the first horizontal section 212 may be approximately 35.0 cm, and a length of the second free end 214 may be approximately 10.0 cm. A length of the second horizontal section 222 may be approximately 35.0 cm, and a third free end 224 may be approximately 17.0 cm. A length of the second feed end 231 may be approximately 13.0 cm, and a length of the fourth free end 233 may be approximately 40.0 cm. In another example, the multiband antenna 100 can be designed with other dimensions.

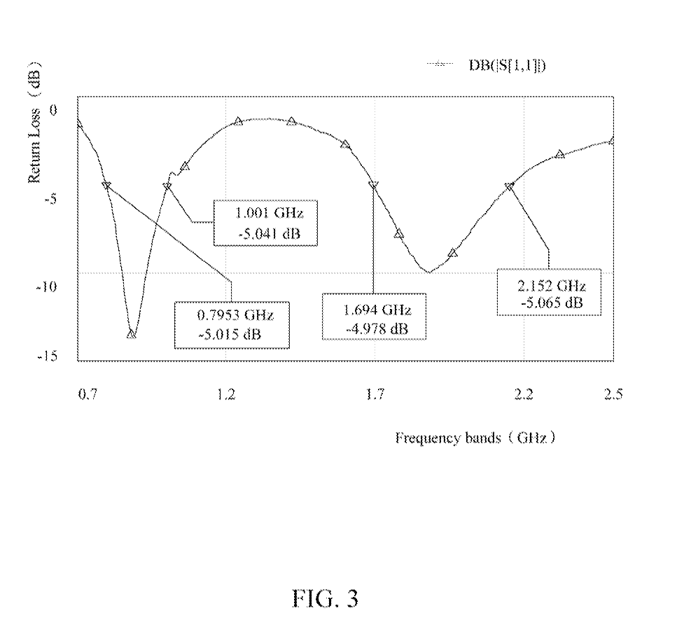

Referring to FIG. 3, an exemplary return loss of the multiband antenna 100 is shown. When the multiband antenna 100 functions at 824 MHz to 960 MHz and 1710 MHz to 2150 MHz, the return loss is less than −5 dB, in accordance with the industry standard. In one embodiment the first radiator 210 functions at high frequency bands of 1710 MHz to 2150 MHz, and the second radiator 220 and the third radiator 230 function at low frequency bands of 824 MHz to 960 MHz.

Although the features and elements of the present disclosure are described as embodiments in particular combinations, each feature or element can be used alone or in other various combinations within the principles of the present disclosure to the full extent indicated by the broad general meaning of the terms in which the appended claims are expressed.

What is claimed is:

1. A multiband antenna, comprising:
a feed portion to feed electromagnetic signals, the feed portion being rectangularly shaped;
a radiating portion connected to the feed portion, to transceive electromagnetic signals, the radiating portion comprising:
a first radiator being a substantially inverted-C shape, connected to the feed portion, wherein the first radiator comprises a first free end and a second free end;
a second radiator being bent and comprising a first feed end and a third free end, wherein the first feed end is connected to the feed portion; and
a third radiator, substantially L shaped and comprising a second feed end and a fourth free end, wherein the second feed end is electrically connected to the feed portion; and
a matching portion, being rectangularly shaped, and electrically connected to the first radiator, for impedance matching.

2. The multiband antenna as claimed in claim 1, wherein the first radiator further comprises a first horizontal section and a first perpendicular section, and wherein the first horizontal section is parallel to the second free end and is longer than the second free end.

3. The multiband antenna as claimed in claim 2, wherein the first horizontal section comprises a first protrusion in the center, and the feed portion and the matching portion are configured on the two ends of the first horizontal section to define slots with the first protrusion.

4. The multiband antenna as claimed in claim 1, wherein the second radiator comprises a second horizontal section and a second perpendicular section.

5. The multiband antenna as claimed in claim 4, wherein the second horizontal section comprises a second protrusion, and the third free end comprises a third protrusion, to adjust frequency bands.

6. The multiband antenna as claimed in claim 1, wherein the third radiator comprises a third perpendicular section, connecting the second feeding section to the fourth free end.

7. The multiband antenna as claimed in claim 6, wherein the second feed portion comprises a fourth protrusion, and the juncture of the feed portion and the third perpendicular section comprises a fifth protrusion to adjust frequency bands.

8. The multiband antenna as claimed in claim 7, wherein the fourth free end is wave-shaped.

9. The multiband antenna as claimed in claim 7, wherein the first free end is vertically to the second free end.

10. The multiband antenna as claimed in claim 9, wherein the third free end and the fourth free end are in the same line and parallel to the second free end.

11. A multiband antenna, comprising:
a feed portion to feed electromagnetic signals;
a radiating portion connected to the feed portion, to transceive electromagnetic signals, wherein the radiating portion comprises a plurality of radiators, and each radiator constitutes one or more L shaped radiating sections connected in series;
a matching portion connected to one of the radiators for impedance matching.

12. The multiband antenna as claimed in claim 11, wherein the feed portion and the matching portion are configured on the same side of the radiating portion.

13. The multiband antenna as claimed in claim 11, wherein the one or more L shaped radiating sections comprise protrusions, respectively.
